(19) United States
(12) Patent Application Publication
(10) Pub. No.: US 2009/0046225 A1
(43) Pub. Date: Feb. 19, 2009

(54) OPTICAL FILM, AND POLARIZING PLATE AND LIQUID CRYSTAL DISPLAY DEVICE USING THE SAME

(75) Inventors: Akihiro MATSUFUJI, Minami-Ashigara-shi (JP); Hiroaki Sata, Minami-Ashigara-shi (JP); Takeichi Tatsuta, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 12/129,817

(22) Filed: May 30, 2008

(30) Foreign Application Priority Data
May 31, 2007 (JP) 2007-145339

(51) Int. Cl. G02F 1/1335; G02B 5/30

(52) U.S. Cl. 349/96; 359/485

(57) ABSTRACT

An optical film includes a cellulose acylate that has a weight-average molecular weight of 300,000 or more; and a compound that is capable of decreasing a retardation in a thickness-direction and has a weight-average molecular weight of 1,000 or more.

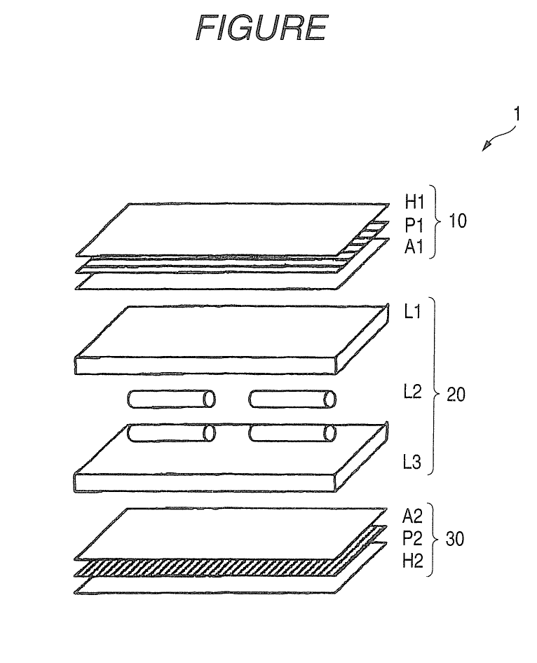

### BACKGROUND OF THE INVENTION

1. Field of the Invention

This invention relates to an optical film, and a polarizing plate and a liquid crystal display device using the same. More specifically, it relates to an optical film which has an optical isotropy and sustains an excellent surface planarity and a high strength even in the case of reducing the film thickness, and a polarizing plate and a liquid crystal display device using the same.

2. Description of the Related Art

Because of having a high toughness and a flame retardancy, cellulose acylate films have been used as supports for photographs and various optical materials. In particular, recently, they have widely been used as optically transparent films for liquid crystal display devices. Since cellulose acylate films have a high optical transparency and a high optical isotropy, they are excellent as optical materials for devices using polarized light such as liquid-crystal display devices. Therefore, they have been used as protective films for polarizers and supports for optically-compensatory films whereby the display viewed from an oblique direction (compensation of viewing angle) can be improved.

In a polarizing plate which is one of the members constituting a liquid-crystal display device, a protective film for a polarizer is formed by bonding to at least one side of the polarizer. In general, a polarizer is obtained by stretching a polyvinyl alcohol (PVA)-based film and then dyeing it with iodine or a dichroic dye.

In many cases, cellulose acylate films, in particular, triacetyl cellulose films, which can be directly bonded to PVA, are employed as the protective film for polarizers. It is important that such a protective film for polarizers is excellent in optical isotropy and the optical properties of the protective film for polarizers largely affect the properties of a polarizing plate.

In recent years, it has been strongly required for liquid crystal display devices to improve a viewing angle property. In its turn, it has been also required that optically transparent films such as protective films for polarizers and supports for optically-compensatory films have improved optically isotropy. To be optically isotropic, it is important that a retardation value represented by the product of birefringence and thickness of the optical film is small. In particular, in order to improve the display viewed from an oblique direction, it is necessary to decrease not only in-plane retardation (Re) but also retardation in a thickness direction (Rth). More specifically speaking, when the optical properties of an optically transparent film are evaluated, it should have a small Re measured in front of the film and its Re should not change even when measured with changing the angle.

Although there have been produced cellulose acylate films having decreased Re measured at the front, a cellulose acylate film having a small change in Re, namely, having a small Rth can be hardly produced. Thus, it has been proposed to use polycarbonate-based films and thermoplastic cycloolefin films instead of cellulose acylate films to give optically transparent films having a small change in Re depending on angle [for example, JP-A-2001-318233 and JP-A-2002-328233; commercially available products such as ZEONOR (manufactured by Nippon Zeon Corporation), ARTON (manufactured by JSR), etc.]. In the case of using these optically transparent films as protective films for polarizers, however, there arises a problem in attachability to PVA owing to the hydrophobic nature of the films. In addition, there remains another problem of the nonuniformity in optical properties over the whole film surface.

To overcome these problems, it has been strongly required to upgrade a cellulose acylate film having an excellent bonding suitability to PVA by lowering the optical anisotropy. More specifically speaking, there has been required to develop an optically transparent film being optically isotropic which has Re measured at the front of a cellulose acylate film of almost zero and a small change in the retardation depending on angle, i.e., Rth of almost zero too.

As a method of producing such a cellulose acylate film having an elevated optical isotropy, there have been disclosed techniques using plasticizers. In producing cellulose acylate films, it is a common practice to add compounds called plasticizers to improve film formation performance. Examples of the plasticizers include phosphoric acid triesters such as triphenyl phosphate and biphenyl diphenyl phosphate, phthalic acid esters and so on. It is known that some of these plasticizers have an effect of lowering the optical anisotropy of cellulose acylate films. For example, specific fatty acid esters are disclosed (see, for example, JP-A-2001-247717). However, sufficient effect of lowering the optical anisotropy of cellulose acylate films cannot be established by using these compounds.

In contrast, JP-A-2006-030937 discloses a technique of producing a cellulose acylate film having an elevated optical isotropy by using a specific additive. JP-A-2005-105139 and JP-A-2005-105140 disclose less optically anisotropic cellulose acylate films containing an organic substance exhibiting optical anisotropy which offsets the optical anisotropy of the cellulose acylate film. However, these techniques suffer from problems such that the optical properties highly depend on wavelength, that the addition of a large amount of a polymer for lowering optical anisotropy damages flexibility or causes cracking in the cutting step, and that the insufficient compatibility result in an increase in haze.

To reduce the display thickness, attempts have been made to reduce the thickness of various members employed therein. Therefore, it is required to reduce the thickness of a protective film for polarizing plates too. Since the anisotropy of optical properties depends on optical path length, reduction in thickness contributes not only to the reduction in display thickness but also to the lowering in the optical anisotropy of the film. In recent liquid crystal display devices, it is also desired to improve display colors. To satisfy this requirement, an optically transparent film such as a protective film for polarizers or a support for optically-compensatory films should have decreased Re and Rth in the visible region of from 400 to 800 nm in wavelength and lessened changes in Re and Rth depending on wavelength, i.e., wavelength dispersion.

### SUMMARY OF THE INVENTION

As discussed above, reduction in film thickness results in a tendency toward worsening of film brittleness. As a result, there frequently arise various problems in performance and productivity, for example, generation of wrinkles and kinks in treating or handling films in the course of the production or processing, edge defects in cutting and so on. In the case of adding the above-described additive capable of decreasing retardation to a cellulose acylate film, these problems accompanying with the film thickness reduction are liable to occur and the cellulose acylate film thus obtained shows step unevenness or a decrease in tear strength. Thus, there has been desired a cellulose acylate film which is excellent in optical isotropy (in particular, Rth) and sustains an excellent surface planarity and a high strength even in the case of reducing the film thickness.

Accordingly, the invention provides an optical film which has an optical isotropy and sustains an excellent surface planarity and a high strength even in the case of reducing the film thickness, and a polarizing plate and a liquid crystal display device using the same.

To solve the above-described problems, the inventors conducted intensive studies. As a result, they have found out that the above problems can be solved by controlling the weight-average molecular weight of a cellulose acylate and the weight-average molecular weight of a compound capable of decreasing the retardation in a thickness-direction (Rth) respectively to specific values or more, thereby completing the present invention.

Accordingly, the constitution of the invention is as follows.

<1> An optical film comprising:

a cellulose acylate that has a weight-average molecular weight of 300,000 or more; and

a compound that is capable of decreasing a retardation in a thickness-direction and has a weight-average molecular weight of 1,000 or more.

<2> The optical film of <1>, wherein

the weight-average molecular weight of the cellulose acylate is from 300,000 to 500,000.

<3> The optical film of <1>, wherein

the weight-average molecular weight of the compound capable of decreasing the retardation in the thickness-direction is from 3,000 to 10,000.

<4> The optical film of <1>, wherein

the compound capable of decreasing the retardation in the thickness-direction is polymethyl methacrylate.

<5> The optical film of <1>, which has a film thickness of 30 to 60 μm.
<6> The optical film of <1>, wherein

an in-plane retardation of the optical film is from 0 nm to 20 nm at the wavelength of 630 nm, and

the retardation in the thickness-direction of the optical film is from −20 in to 20 nm at the wavelength of 630 nm.

<7> The optical film of <1>, which satisfies the following formula (1):

|Rth(630)−Rth(480)|≦20 Formula (1)

wherein

Rth(630) represents the retardation in the thickness-direction of the optical film at the wavelength of 630 nm, and

Rth(480) represents the retardation in the thickness-direction of the optical film at the wavelength of 480 nm.

<8> A polarizing plate comprising:

a polarizer; and

the optical film of <1> that is a protective film of the polarizer.

<9> A liquid crystal display device comprising:

the polarizing plate of <8>.

### BRIEF DESCRIPTION OF THE DRAWING

FIGURE is a perspective model diagram illustrating a preferable embodiment of the polarizing plate and liquid crystal display device using the optical film according to the invention.

### DETAILED DESCRIPTION OF THE INVENTION

Next, the invention will be described in greater detail.

The optical film of the invention comprises a film (a cellulose acylate film) which comprises a cellulose acylate having a specific weight-average molecular weight and a compound being capable of decreasing the retardation in a thickness-direction and having a specific weight-average molecular weight.

First, the components constituting the cellulose acylate film will be illustrated.

### [Cellulose Acylate]

As the cellulose acylate raw material for use in the invention, use can be made of cellulose materials such as wood pulp, cotton fiber linter or the like as reported in Hatsumei Kyokai Kokai Giho No. 2001-1.745, etc. Cellulose acylates can be synthesized by methods described in Mokuzai Kagaku, pp. 180 to 190 (Kyoritsu Shuppan, Migita, et al., 1968), etc.

As the results of intensive studies on problems accompanying with film thickness reduction, it is found out that these problems can be overcome by increasing the molecular weight of cellulose acylate.

The specific weight-average molecular weight of the cellulose acylate to be used in the invention is preferably from 300,000 to 500,000 and more preferably from 330,000 to 400,000. When the weight-average molecular weight is less than 300,000, the film becomes brittle and handling properties are worsened. From the viewpoints of achieving a good solubility and avoiding an excessively high dope viscosity, the weight-average molecular weight is preferably not more than 500,000. The weight-average molecular weight means a value measured by commonly employed GPC in the state of dissolved in methylene dichloride and expressed in terms of PMMA.

Although the acyl group in the cellulose acylate is not particularly restricted, an acyl group having from 2 to 4 carbon atom is preferred. It is preferable to use an acetyl group or a propionyl group and an acetyl group is particularly preferable. The total acyl-substitution degree is preferably from 2.8 to 3.0 and more preferably from 2.8 to 2.95. In the case of using a cellulose acetate wherein all of the acyl groups are acetyl groups, the degree of acetyl-substitution is preferably from 2.8 to 2.95 and more preferably from 2.85 to 2.95. From the viewpoint of minimizing the variation in Re and Rth, it is preferable to use a cellulose acetate having a degree of acyl-substitution at the 6-position is 0.9 or more. At a degree of substitution of 2.8 or more, optical anisotropy is scarcely expressed. On the other hand, a degree of substitution of 2.95 is preferred since a high solubility can be obtained, which facilitates the production. The degree of acyl-substitution employed herein is a value calculated in accordance with ASTM D817.

It is also preferable to control the contents of Ca, Fe and Mg in a cellulose acylate film respectively within the ranges as described in JP-A-12-313766.

### [Compound Capable of Decreasing the Retardation in Thickness-Direction]

The compound capable of decreasing the retardation in a thickness-direction to be used together with the cellulose acylate in the invention is a compound which shows such an optical anisotropy as decreasing the optical anisotropy, in particular Rth, of the cellulose acylate. The compound capable of decreasing the retardation in a thickness-direction is a compound having the properties of decreasing the optical anisotropy expressed by the cellulose acylate, i.e., being oriented in parallel to the cellobiose skeleton and having a large refractive index to the direction perpendicular to its own molecular axis.

The compound capable of decreasing the retardation in a thickness-direction is not particularly restricted so long as it has the properties as described above. It is preferable to use a high molecule compound being highly compatible with the cellulose acylate and having a negative intrinsic birefringence.

More specifically speaking, it is preferable to use a compound having an ester group against the optical anisotropy of the acyl group in the cellulose acylate. Preferable examples thereof include acrylic acid-based polymers, methacrylic acid-based polymers and copolymers thereof. As the acrylic acid-based polymers and the methacrylic acid-based polymers, there can be enumerated homopolymers and copolymers of methyl ester of acrylic acid or methacrylic acid, ethyl ester of acrylic acid or methacrylic acid, phenyl ester of acrylic acid or methacrylic acid, benzyl ester of acrylic acid or methacrylic acid, etc. Acrylic acid-based polymers and methacrylic acid-based polymers are preferable because of having a refractive index close to cellulose acylates. Among all, it is particularly preferable to use polymethyl methacrylate (PMMA).

In addition, use can be preferably made of polyester polyurethane oligomers, polyester oligomers and the like which are compatible with cellulose acylates.

The compound for decreasing the retardation in a thickness-direction as described above should have a weight-average molecular weight of 1,000 or more, preferably from 2,000 to 20,000 and more preferably from 3,000 to 15,000. This is because a small molecular weight causes an increase in the volatilization loss during the drying step following casting. By determining the upper limit as described above, bleed-out can be avoided (regulated). The weight-average molecular weight means the value of weight-average molecular weight in terms of PMMA determined by GPC.

The compound capable of decreasing the retardation in a thickness-direction having the weight-average molecular weight as described above can be obtained by polymerization in a solvent easily allowing chain transfer such as toluene or isopropyl alcohol (IPA), polymerization in the presence of a chain transfer agent such as β-mercaptopropionic acid or thioglycerol, polymerization at a low monomer/polymerization initiator ratio, or polymerization under combining these conditions.

A condensation polymer can be prepared by altering the feeding ratio of a dibasic acid to a dihydric alcohol, or a monobasic acid to a monohydric alcohol.

From the viewpoints of preventing phase separation or bleeding and maintaining uniformity and preventing the film properties from worsening, it is preferable to add the compound capable of decreasing the retardation in a thickness-direction in an amount of from 5 to 30 parts by mass and more preferably from 10 to 25 parts by mass per 100 parts by mass of the cellulose acylate.

### [Wavelength Dispersion Regulator]

Although Rth of the film can be decreased by adding the compound capable of decreasing the retardation in a thickness-direction as described above, Rth of cellulose acylate changes from wavelength to wavelength. Thus, it is sometimes observed that the Rth in the long wavelength side largely differs from the Rth in the short wavelength side. It is preferable that the Rth at the wavelengths of 480 nm and the Rth at the wavelengths of 630 nm has a relation satisfying the following formula:

|Rth(630)−Rth(480)|≦20 Formula (1)

To satisfy the relationship represented by the formula (1), it is preferable to use a wavelength dispersion regulator. As the wavelength dispersion regulator, a compound having a benzotriazole, benzophenone, cyanoacrylate or triazine skeleton as the main moiety, which may be substituted by various substituents, is preferred. Preferable examples will be presented below, though the invention is not restricted thereto. In the following structural formulae, R stands for an organic substituent, and R′ stands for H, OH or an organic substituent. Examples of the organic substituents include alkyl groups having from 1 to 12 carbon atoms, aryl groups and so on. It is preferable that these compounds have an absorption in the ultraviolet region of 200 to 400 nm but no absorption in the visible region.

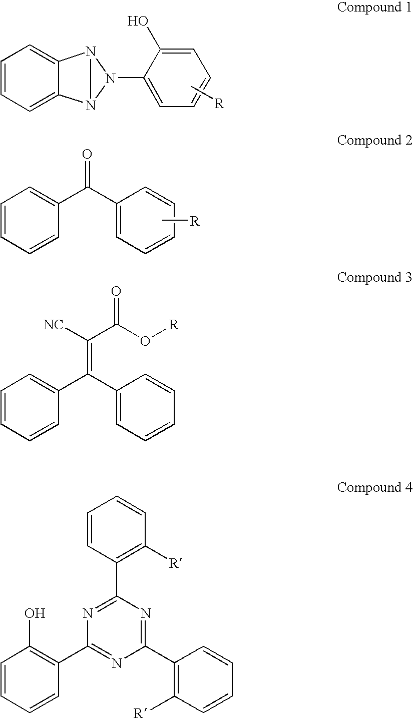

Examples of compound 1 include 2-(2-hydroxy-5-t-octylphenyl)-2H-benzotriazole, 2-(2-hydroxy-5-methylphenyl)-2H-benzotriazole, 2-(2-hydroxy-5-t-butylphenyl)-2H-benzotriazole, 2-(2-hydroxy-3-t-butyl-5-methylphenyl)-2H-benzotriazole, 2-(2-hydroxy-3,5-di-t-butylphenyl)-2H-benzotriazole, 2-(2-hydroxy-3,5-di-t-pentylphenyl)-2H-benzotriazole, 2-[2-hydroxy-3-(3,4,5,6-tetrahydrophthalamide-methyl)-5-methylphenyl]benzotriazole, esters of benzene propanoic acid-3-(2H-benzotriazol-2-yl)-5-(1,1-dimethylethyl)-4-hydroxy with branched and linear C₇₋₉ alkyls, 2-(2-hydroxy-3,5-bis(1,1-methyl-1-phenylethyl)phenyl)-2H-benzotriazole and so on.

Example of compound 2 include 2-hydroxy-4-n-hectoxybenzophenone, 2-hydroxy-4-n-octoxybenzophenone, 2-hydroxy-4-benzyloxybenzophenone, 2,2′-dihydroxy-4,4′-dimethoxybenzophenone, 2,2′-dihydroxy-4-methoxybenzophenone and so on.

Examples of compound 3 include ethyl-2-cyano-3,3-diphenyl acrylate, (2-ethylhexyl)-2-cyano-3,3-diphenyl acrylate, decyl-2-cyano-3-(5-methoxy-phenyl)acrylate and so on.

Examples of compound 4 include 2,4-bis[2-hydroxy-4-butoxyphenyl]-6-(2,4-dibutoxyphenyl)-1,3,5-triazine, 2-(2,4-dihydroxyphenyl)-4,6-bis-(2,4-dimethylphenyl)-1,3,5-triazine, 2-(2-hydroxy-4-butoxyphenyl)-4,6-diphenyl-1,3,5-triazine and so on.

As other compounds, there can be enumerated esters, for example, salicylic acid esters such as phenyl salicylate and tolyl salicylate, (2,4-di-t-butyl)phenyl-(4-hydroxy,3,5-di-t-butyl)benzoate, and so on.

Benzophenone compounds and ester compounds are still preferred.

The content of the wavelength dispersion regulator is preferably from 0.1 to 30 parts by mass, more preferably from 0.2 to 10 parts by mass and more preferably from 0.5 to 2 parts by mass per 100 parts by mass of the cellulose acylate. From the viewpoints of the coloration in the visible part and the |Rth(630)−Rth(480)| value, it is preferable to add the wavelength dispersion regulator in an amount within the range as specified above.

### [Plasticizer]

In the invention, it is possible to further add a plasticizer having a plasticizing effect, if necessary. As specific examples of the plasticizer, it is preferable to use a compound having a functional group such as a phosphoric acid ester, a carboxylic acid ester, an amide, an ether or a urethane. Preferable examples of such a compound are as follows, though the invention is not restricted thereto.

Examples of the phosphoric acid ester include triphenyl phosphate, biphenyl diphenyl phosphate, tricresyl phosphate, cresyl diphenyl phosphate, octyl diphenyl phosphate, trioctyl phosphate, tributyl phosphate, resorcinol bisdiphenyl phosphate, 1,3-phenylene bisdixylenyl phosphate, bisphenol A bisdiphenyl phosphate and so on.

Examples of the carboxylic acid ester include polyhydric alcohol carboxylic acid esters such as trimethylolpropane tribenzoate, trimethylolpropane tricyclohexyl carboxylate, pentaerythritol tetrabutylate, glycerol tributylate, triacetin, tributylin and tripropionin; saturated or unsaturated polyhydric carboxylic acid esters such as dibutyl succinate, diphenyl adipate, dibutyl phthalate, diaryl phthalate, dimethyl phthalate, diethyl phthalate, di-2-methoxyethyl phthalate, dioctyl phthalate, di-2-ethylhexyl phthalate, trimethyl trimellitate and tetraethyl pyromellitate; and oligomers of methyl methacrylate and ethyl acrylate.

Examples of the oxy acid ester include esters of oxy acids such as glycolic acid, salicylic acid, citric acid, malic acid and tartaric acid, e.g., triethyl citrate, acetyl/triethyl citrate, dibutyl tartarate, dibutyl diacetyltartarate, butyl phthalyl butyl glycolate, ethyl phthal ethyl glycolate, methyl phthalyl ethyl glycolate, butyl phthalyl butyl glycolate.

Examples of the amide include carboxylic acid amides and sulfonic acid amides such as N-phenyl-benzene carbonamide, N-phenyl-p-toluene sulfonamide and N-ethyltoluene sulfonamide.

In addition, use can be made of a sulfonic acid ester such as o-cresyl p-toluenesulfonate, a urethane obtained by reacting toluene diisocyanate with an alcohol such as ethanol or hexyl alcohol.

As preferable examples, low-molecule ethers such as an ether oligomer such as glycidyl ether of bisphenol A and an urethane oligomer obtained by reacting toluene diisocyanate with a mixture of a dihydric alcohol and a monohydric alcohol may be cited.

Furthermore, trityl alcohol and the like may be cited as preferable examples.

The plasticizer is added preferably in an amount of from 1 to 30 parts by mass, more preferably from 5 to 15 parts by mass per 100 parts by mass of the cellulose acylate.

Next, an embodiment of the optical film according to the invention will be described. Further, an embodiment of the polarizing plate according to the invention and an embodiment of the liquid crystal display device according to the invention will be successively described.

### [Optical Film]

The optical film according to the invention comprises a cellulose acylate film which comprises a cellulose acylate as described above and a compound being capable of decreasing the retardation in a thickness-direction as described above. It is appropriately used mainly as a protective film for a polarizer and a support for an optically-compensatory film.

It is required that a protective film for a polarizer has such properties as a high transparency, a low optical anisotropy, an appropriate rigidity and so on. Therefore, the optical film of the invention preferably has a transmittance of 80% or higher and more preferably 90% or higher. Its haze is preferably 2.0% or less and more preferably 1.0% or less. Its refractive index is preferably from 1.4 to 1.7.

The glass transition temperature of the optical film of the invention is preferably 100° C. or higher but lower than 200° C. and more preferably 120° C. or higher but lower than 180° C.

It is particularly preferable to use the cellulose acylate film of the invention in a liquid crystal display device of the IPS mode. To minimize light leakage and a change in viewing angle of tint caused by the disagreement of the polarization direction the light having passed through the polarizing plate in the light source side and the absorption axis of the front polarizing plate, and, in the case of using in combination with an optically anisotropic layer with birefringence, to make the cellulose acylate film according to the invention to show no undesirable anisotropy so that the optical performance of the optically anisotropic layer alone can be expressed, it is preferable that the optical film of the invention has Re at the wavelength of 630 nm of 0 to 20 nm and more preferably 0 to 10 nm, and Rth at the wavelength of 630 nm of −20 nm to 20 nm and more preferably −10 to 10 nm.

It is preferable that the optical film of the invention is produced by the solvent casting method. From the viewpoint of minimizing the variation in Re and Rth, it is desirable that the solid concentration of a cellulose acylate solution, which is prepared by dissolving the cellulose acylate, the compound being capable of decreasing the retardation in a thickness-direction and other additive(s) in an organic solvent, is from 16% by mass to 30% by mass and more preferably from 18% by mass to 26% by mass. As the organic solvent to be used here, it is preferable to use a mixture of a chlorinated solvent, an alcohol, a ketone and an ester, though the invention is not restricted thereto. As the chlorinated solvent, methylene dichloride or chloroform is preferred. It is particularly preferable to use methanol, ethanol, 1-propanol, 2-propanol or 1-butanol as the alcohol, methyl acetate as the ester and acetone, cyclopentanone or cyclohexanone as the ketone.

To prepare the cellulose acylate solution, the above-described cellulose acylate is first added to the solvent in a tank under stirring for swelling. The swelling time is preferably 10 minutes or longer, since no undissolved matter remains in this case. The solvent temperature is preferably from 0 to 40° C. A temperature of 0° C. or higher is preferred from the viewpoints of preventing a lowering in swelling speed and avoiding the formation of undissolved residue. On the other hand, a temperature of not higher than 40° C. is preferred from the viewpoint of preventing rapid swelling and allowing the center part to sufficient swell. To dissolve the cellulose acylate, use can be made of either or both of the cold dissolution method and the hot dissolution method. As detailed procedures in the cold dissolution method and hot dissolution method, publicly known ones as reported in Hatsumei Kyokai Kokai Giho No. 2001-1.745, etc. can be employed. It is also preferable in some cases that the cellulose acylate solution as described above is prepared by dissolving at a low temperature and then concentrating the resultant solution to give the optimum concentration with the use of a concentration procedure.

In the course of preparing the cellulose acylate solution (dope), it is possible to add other additive(s) suitable for the purpose. Examples of these additives include an antioxidant, a peroxide decomposing agent, a radical inhibitor, a metal inactivating agent, an acid scavenger, a degradation preventing agent such as a hindered amine, a peeling agent, a matting agent (metal oxide microparticles) and so on.

As the process and apparatus for producing the cellulose acylate film of the invention, a solution-casting film-preparation process and a solution-casting film-preparation apparatus for conventional production of cellulose triacetate films are employed. A dope (cellulose acylate solution) prepared from a dissolution tank is once stored in a stock tank and bubbles contained in the dope are removed, whereby the dope is finally prepared. The dope is delivered from a dope discharging port into a pressurized die via a pressurized proportioning gear pump ensuring quantitative feeding at a high accuracy. Next, the dope is uniformly cast onto a metal support (a band or a drum) in the casting part traveling endlessly from a slit of the pressure die. Then, the half-dried dope film (also called a web) is peeled off from the metal support. The peeled web is held at both ends with clips or pin tenters for width-regulating and dried by carrying with a tenter. Subsequently, it is carried with rolls of a dryer and wound up in a definite length with a winding machine. The combination of the drying units, i.e., the tenter and the rolls, the temperatures at the individual units and the amounts of the residual solvent at the individual points can be altered depending on the purpose.

In the present invention, the film can be stretched so that the film width at the tenter outlet exceeds the film width at the tenter inlet to thereby achieve the desired Re. Although the stretching ratio varies depending on the desired Re, it is preferably from 1.0 to 1.3-fold and more preferably from 1.0 to 1.25-fold. The amount of the residual solvent at the stretching step is preferably from 2% by mass to 35% by mass and more preferably from 2% by mass to 30% by mass. It is preferable that the amount of the residual solvent is 2% by mass or more from the viewpoint of preventing wrinkle generation and film breakage. It is also preferable that the amount of the residual solvent is not more than 30% by mass from the viewpoints of achieving the sufficient effect of the stretching and controlling Re. To control Re, the tension in the carrying step may be regulated within such a range as causing no problem in handling.

To lessen variation in film thickness and lessen variation in optical anisotropy, it is preferable in the invention to cast the cellulose acylate solution on a smooth band or drum employed as a metal support. It is also possible to co-cast a plurality of cellulose acylate solutions.

In the production of the optical film according to the invention, the dope is dried on the metal support preferably at 30 to 250° C., more preferably at 40 to 180° C. and most preferably at 40 to 140° C.

The final (dry) film thickness of the optical film according to the invention preferably ranges from 30 to 60 μm and more preferably from 40 to 60 μm. For regulating the film thickness, the solid matter content in the dope, slit gap of mouthpiece of the die, extrusion flow rate and pressure from the die, the speed of the metal support, and the like may be controlled so as to achieve a desired thickness.

The tear strength of the film can be measured by using an Elmendorf tear strength machine in accordance with JIS K 7128. In the case where the tear strength is too small, the film is easily torn. In the case where it is too large, the film becomes hard and brittle. Thus, the tear strength is preferably 0.1 N or more and more preferably 0.15 N or more. Since the tear strength relates to the film thickness, it is preferably 0.002 N/μm of the film thickness.

### [Polarizing Plate]

The polarizing plate according to the invention has the optical film of the invention as described above as a protective film of a polarizer.

Namely, the optical film of the invention can be used as a protective film in a polarizing plate. In general, a polarizing plate comprises a polarizer and two sheets of transparent protective films provided in both sides thereof. The optical film of the invention can be used as at least one of the protective films. As the other protective film, a commonly employed cellulose acetate film may be used. The polarizer includes an iodine-containing polarizer, a dye-containing polarizer using a dichroic dye, and a polyene-based polarizer. The iodine-containing polarizer and the dye-containing polarizer are generally produced using a polyvinyl alcohol-based film. In the case of using the optical film of the invention as a protective film for the polarizing plate, the method for fabricating the polarizing plate is not particularly limited, and the polarizing plate may be fabricated by a commonly employed method. There is a method which comprises treating the resultant cellulose acylate film or a commonly employed cellulose acetate film with an alkali and bonding the film on one or both sides of a polarizer, which has been fabricated by dipping a polyvinyl alcohol film in an iodine solution and stretching, using an aqueous solution of a completely saponified polyvinyl alcohol. As a substitute for the alkali treatment, a simplified adhesive processing as described in JP-A-6-94915 and JP-A-6-118232 may be conducted. Examples of the adhesive to be used for adhering the treated surface of the protective film to the polarizer include adhesives having polyvinyl alcohol such as polyvinyl alcohol or polyvinyl butyral as the base and latexes having vinyl such as a butyl acrylate as the base.

In bonding the optical film of the invention to the polarizer, it is preferable that the optical film is bonded along the absorption axis of the polarizer and the longitudinal direction of the optical film of the invention, to thereby enable continuous production.

### [Optically-Compensatory Film]

Furthermore, the optical film according to the invention can be used as a support for optically-compensatory films. Namely, an optically-compensatory film can be fabricated by forming an optically-compensatory layer on the optical film of the invention. It is preferable that the optically-compensatory layer is provided with, if necessary, an alignment layer.

The alignment layer can be provided by a measure such as a rubbing treatment of an organic compound (preferably a polymer), oblique vapor deposition of an inorganic compound, and formation of a layer having micro grooves. In addition, there is known an alignment layer the orientation function of which is generated by imparting an electrical field, imparting a magnetic field, or irradiating light. However, an alignment layer as formed by a rubbing treatment of a polymer is especially preferable. The rubbing treatment is preferably carried out by rubbing the surface of a polymer layer with a paper or a cloth several times in a fixed direction. It is preferable that the absorption axis of the polarizer and the rubbing direction are substantially parallel to each other. With respect to the kind of the polymer to be used in the alignment layer, use can be preferably made of polyimide, polyvinyl alcohol, a polymerizable group-containing polymer as described in JP-A-9-152509, and the like. The thickness of the alignment layer is preferably from 0.01 to 5 μm, and more preferably from 0.05 to 2 μm.

It is preferable that the optically anisotropic layer contains a liquid crystalline compound. It is especially preferable that the liquid crystal compound which is used in the invention is a discotic liquid crystal compound or a rod-shaped liquid crystal compound.

### [Discotic Liquid Crystal Compound]

Examples of the discotic liquid crystal compound usable in the invention include compounds described in various references (C. Destrade et al, MoI. Crysr. Liq. Cryst., Vol. 71, p. 111 (1981); Quarterly Journal of Outline of Chemistry, by the Chemical Society of Japan, No. 22, Chemistry of Liquid Crystal, Chap. 5, Chap. 10, Sec. 2 (1994); B. Kohne et al., Angew. Chem. Soc. Chem. Comm., p. 1794 (1985); J. Zhang et al., J. Am. Chem. Soc., Vol. 116, p. 2655 (1994)). As in a triphenylene derivative, a discotic liquid crystal molecule has a structure in which side chains radially extends from a disc-shaped core. To impart stability with the passage of time, it is also preferable to further introduce a group reactive to heat, light, etc. Preferable examples of the discotic liquid crystals as described above are presented in JP-A-8-50206.

The discotic liquid crystal molecule is oriented substantially parallel to the film plane with a pre-tilt angle against the rubbing direction in the vicinity of the alignment layer, and in the opposite air surface side, the discotic liquid crystal molecule stands up and is oriented in a substantially vertical form against the plane. The whole of the discotic liquid crystal layer takes hybrid orientation, and viewing angle enlargement of TFT-LCD of a TN mode can be realized by this layer structure.

### (Rod-Shaped Liquid Crystal Compound)

Examples of the rod-shaped liquid-crystal compound usable in the invention include azomethines, azoxy compounds, cyanobiphenyls, cyanophenyl esters, benzoic acid esters, phenyl cyclohexanecarboxylates, cyanophenylcyclohexanes, cyano-substituted phenylpyrimidines, alkoxy-substituted phenylpyrimidines, phenyldioxanes, tolans, and alkenylcyclohexylbenzonitriles. Not only such low-molecular liquid-crystal compounds, but also high-molecular liquid-crystal compounds may also be usable herein.

The above-described optically anisotropic layer is usually obtained by coating a solution of a liquid crystal compound and other compounds (and optionally a polymerizable monomer and a photopolymerization initiator) dissolved in a solvent on the alignment layer, drying, heating the coated alignment layer to the nematic phase-forming temperature, subjecting the coated alignment layer to polymerization by irradiation with UV rays or the like, and then cooling.

Alternatively, the optically anisotropic layer may be a non-liquid crystal polymer layer prepared by dissolving a non-liquid crystal compound in a solvent, coating the solution on a support, and drying the coat layer. As the non-liquid crystal compound to be used in this case, use may be made of a polymer such as a polyamide, a polyimide, a polyester, a polyether ketone, a polyaryl ether ketone, a polyamide imide or a polyester imide because of being excellent in heat resistance, chemical resistance and transparency and rich in rigidity. Any of these polymers may be used singly. Alternatively, two or more of these polymers having different functional groups, for example, a polyaryl ether ketone and a polyamide may be used in admixture. Among these polymers, a polyimide is preferable because of having a high transparency, a high alignability and a high stretchability. As the support, a TAC film is preferred.

It is also preferred that the laminate of a non-liquid crystal layer and a support is crosswise stretched 1.05-fold using a tenter and then bonded to a polarizer on the support side thereof.

Further, the optically anisotropic layer may be a solidified alignment layer of a cholesteric liquid crystal having a selective reflection wavelength of 350 nm or less. As the cholesteric liquid crystal, use may be made of an appropriate compound having a selective reflection characteristics as described above, for example, a compound disclosed in JP-A-3-67219, JP-A-3-140921, JP-A-5-61039, JP-A-6-186534 or JP-A-9-133810. Examples of the cholesteric liquid crystal which can be preferably used from the viewpoint of stability of solidified alignment layer, etc. include cholesteric liquid crystal polymers, nematic liquid crystal polymers having a chiral agent incorporated therein, and compounds capable of forming a cholesteric liquid crystal layer made of a compound undergoing photopolymerization or thermal polymerization to form such a liquid crystal polymer.

In this case, the optically anisotropic layer can be formed, for example, by a method whereby a cholesteric liquid crystal is coated on a support. In this case, it is possible to employ a method of multi-layer coating of the same or different cholesteric liquid crystals as necessary for the purpose of controlling phase difference or the like. The coating of the cholesteric liquid crystal can be carried out by any appropriate method such as the gravure coating method, the die coating method or the dip coating method.

In forming the optically anisotropic layer as described above, a procedure for aligning the liquid crystal is conducted. The procedure for aligning the liquid crystal is not specifically limited and any procedure for aligning the liquid crystal may be employed. Examples thereof include a procedure whereby a liquid crystal is coated on an alignment film followed by the alignment. Examples of the alignment film thus formed include a rubbed film made of an organic compound such as a polymer, an obliquely deposited film of an inorganic compound, a film having a microgroove, and an film fabricated by accumulating LB films of an organic compound such as ω-tricosanic acid, dioctadecylmethylammonium chloride or methyl stearate by Langmuir-Blodgett method. Further, use may be made of an alignment film which undergoes alignment when irradiated with light. On the other hand, use may be made of a procedure which comprises coating a liquid crystal on a stretched film, and then aligning the liquid crystal (JP-A-3-9325), and a procedure which comprises aligning a liquid crystal under the application of an electric field or magnetic field. The alignment of the liquid crystal molecules is preferably as uniform as possible. The solidified layer as described above preferably has liquid crystal molecules fixed so aligned.

It is also possible to employ such an optically-compensatory film as one face of the protective film of a polarizing plate that has a polarizer in the side opposite to the side having the optically-compensatory film as described above.

### [Liquid Crystal Display Device]

The liquid crystal display device according to the present invention is one using the polarizing plate of the invention as described above.

The polarizing plate of the invention is bonded to a liquid crystal cell of a liquid crystal display device using, for example, a pressure-sensitive adhesive. It is preferable that the optical film of the invention is provided as a protective film in the liquid crystal cell side of the polarizing plate.

The optical film may be bonded to both or one of the sides of the liquid crystal cell. Also, use can be made of a combination of optical films having different optical properties.

An optical film of the invention having a low optical anisotropy is particularly preferably used in a liquid crystal cell of IPS mode and it is preferably provided in both sides of the liquid crystal cell. A cellulose acylate film having an optically-compensatory layer is preferably used in VA and OCB modes.

Now, the polarizing plate and liquid crystal display device according to the invention will be described by referring to FIGURE.

FIGURE is a perspective model diagram illustrating an embodiment of the polarizing plate and liquid crystal display device according to the invention.

A liquid crystal cell 1 shown in FIGURE comprises an upper polarizing plate 10, a liquid crystal cell 20 and a lower polarizing plate 30. The upper polarizing plate 10 is composed of a protective film H1, a polarizer P1 and a protective film A1 laminated together. The liquid crystal cell 20 is composed of a phase difference film A L1, a liquid crystal layer L2 and a phase difference film B L3 laminated together. The lower polarizing plate 30 is composed of a protective film A2, a polarizer P2 and a protective film H2 laminated together. This embodiment shows a polarizing plate according to the invention wherein the upper polarizing plate 10 and the lower polarizing plate 30 have the optical film of the invention respectively as the protective films A1 and A2.

Also, a backlight source is provided, though it is not shown in the drawing.

### EXAMPLE

Next, the invention will be described in greater detail by referring to the following Examples. The materials, reagents, amount and proportion of materials, procedures and other factors defined hereinafter may be appropriately changed unless they depart from the spirit of the invention. Accordingly, the scope of the invention is not specifically limited to the following examples.

### (Preparation of Cellulose Acetate Solution)

As Table 1 shows, cellulose acetates are prepared by changing the conditions, i.e., the catalyst amount employed in the acetyl-substitution, reaction concentration, reaction temperature, reaction time and so on. Using each cellulose thus obtained, the following composition is put into a mixing tank and stirred to dissolve the individual components. Thus, a cellulose acetate solution is prepared.

### (Composition of Cellulose Acetate Solution)

| | | |
|---|---|---|
| Cellulose acetate | 100.0 | parts by mass |
| Methylene chloride (first solvent) | 400.0 | parts by mass |
| Methanol (second solvent) | 60.0 | parts by mass |

As the compound capable of decreasing the retardation in a thickness-direction and the wavelength dispersion regulator, the individual compounds are prepared each in the amount as specified in Table 1 and added to the mixing tank. After dissolving, each component is mixed with the cellulose acetate solution and the solid concentration of the resultant mixture is further adjusted to 20% by mass, thereby giving a dope.

### (Formation of Transparent Film Using Cellulose Acetate Dope)

The above-described cellulose acetate dope is filtered and cast by using a band casting machine. When the residual solvent content attains 30% by mass, the film is peeled off from the band and tenter-stretched. After drying until the residual solvent content attains 0.2% by mass or less at 140° C., the film is cooled and wound. Thus, the samples of Comparative Examples and Examples shown in Table 1 are formed.

TABLE 1

| | | | | | | | | Wavelength dispersion | | |
|---|---|---|---|---|---|---|---|---|---|---|
| | | Cellulose acylate | | | Compound decreasing Rth, plasticizer | | | regulator | | Film |
| | | Degree of | Wt-average | | | Wt-average | Addition level | | Addition level | thickness |
| Ex. | | Substitution | molecular weight | Mw/Mn | | molecular weight | (% by mass) | | (% by mass) | (μm) |
| Comp. | 1 | 2.86 | 220,000 | 3.0 | PMMA | 10,000 | 20 | Triazole | 1.2 | 51 |
| Ex. | 2 | | | | PMMA | 10,000 | 20 | Triazole | 1.2 | 80 |
| Ex. | 3 | 2.86 | 345,000 | 3.0 | PMMA | 10,000 | 20 | Triazole | 1.2 | 50 |
| Comp. | 4 | 2.94 | 260,000 | 2.6 | PMMA | 10,000 | 15 | Triazine | 1.2 | 48 |
| Ex. | 5 | | | | PMMA | 5,000 | 15 | Triazine | 1.2 | 52 |
| | 6 | | | | PMMA | 10,000 | 15 | Triazine | 1.2 | 80 |
| Ex. | 7 | 2.94 | 360,000 | 2.9 | PMMA | 10,000 | 15 | Triazine | 1.2 | 50 |
| | 8 | 2.94 | 360,000 | 2.9 | PMMA | 5,000 | 15 | Triazine | 1.2 | 52 |
| Comp. Ex. | 9 | 2.94 | 360,000 | 2.9 | PMMA | 600 | 15 | Triazine | 1.2 | 50 |
| Comp. Ex. | 10 | 2.94 | 360,000 | 3.0 | TPP | 326 | 84 | Triazine | 1.2 | 50 |
| | | | | | BDP | 402 | | | | |

The GPC conditions employed in the measurement are as follows.

Solvent: chloroform

Solvent concentration: 1 mg/ml

Device: TOSO HLC-8220 GPC

Mw and Mn, which can be determined by the above measurement, respectively represent weight-average molecular weight and number-average molecular weight.

As the wavelength dispersion regulators listed in Table 1, compounds having the following structures are used.

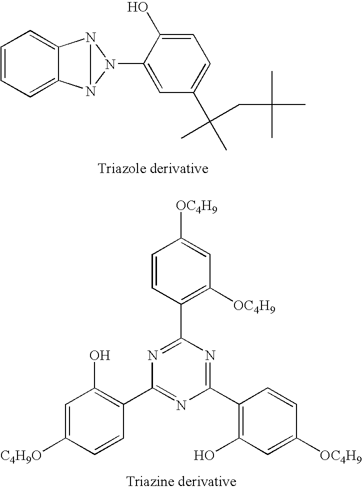

In Table 1, TPP stands for triphenyl phosphate, while BDP stands for biphenyl diphenyl phosphate.

### (1-6) Evaluation and Results

The obtained films are tested in the following items. Table 2 shows the results.

### (1) Film Surface Planarity

The step unevenness of each film thus formed is observed in the longitudinal and width directions with the naked eye.

A: Little unevenness is observed.

B: Nonperiodical unevenness is observed.

C: Periodical unevenness is observed.

### (2) Film Roughness

Using FUJINON laser interferometer F601, unevenness in the thickness in 60 mm (diameter) area of each film thus formed is measured and the square mean roughness is employed in evaluating the surface planarity.

### (3) Optical Properties of Film

In the present specification, Re(λ) and Rth(λ) represent an in-plane retardation and a retardation in a thickness direction at a wavelength of λ, respectively. The Re(λ) is measured by making light having a wavelength of λ nm incident into the normal line direction in KOBRA 21ADH or WR (manufactured by Oji Science Instruments).

In the case where a film to be measured is expressed by a monoaxial or biaxial index ellipsoid, Rth(λ) can be calculated by the method as described below.

Rth(λ) is calculated by KOBRA 21ADH or WR based on six Re(λ) values, which are measured for incoming light of a wavelength λ nm in six directions which are decided by a 10° step rotation from 0° to 50° with respect to the normal direction of a sample film using an in-plane slow axis, which is decided by KOBRA 21ADH, as an a tilt axis (a rotation axis; defined in an arbitrary in-plane direction if the film has no slow axis in plane); a value of hypothetical mean refractive index; and a value entered as the film thickness.

In the case of a film giving no retardation, (i.e., zero) for incoming light in the direction rotated at a certain angle with respect to the normal direction of the film using an in-plane slow axis as a rotation axis, any retardation values obtained at angles larger than that angle will be calculated by KOBRA 21 ADH or WR, after being inverted in the sign to minus.

It is to be noted that Rth can be also calculated from the following equations (2) and (3), based on two retardation values measured for incoming light in two rotated directions, while assuming the slow axis as a tilt axis (a rotation axis: defined in an arbitrary in-plane direction if the film has no slow axis); a hypothetical value of the mean refractive index, and an entered value of the film thickness.

$$Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} \qquad Formula ( 2 )$$

### Remarks:

In the above formula, Re(θ) represents retardation value in the direction rotated by angle θ from the direction of normal line.

In the above formula (2), nx represents in-plane refractive index in the direction of slow axis; ny represents in-plane refractive index in the direction normal to nx; nz represents refractive index in the direction normal to nx and ny; and d is the thickness of the film.

Rth=((nx+ny)/2−nz)xd Formula (3)

In the case where a film to be measured is not expressed by a monoaxial or biaxial index ellipsoid, i.e., a so-called optic axis-free film, Rth(λ) can be calculated by the method as described below.

The Re(λ) is measured by using KOBRA-21ADH or WR for an incoming light of a wavelength λ nm in a vertical direction to a film-surface. The Rth(λ) is calculated by using KOBRA-21ADH based on plural retardation values which are measured for incoming light of a wavelength λ nm in eleven directions which are decided by a 10° step rotation from −50° to +50° with respect to the vertical direction of the film using an in-plane slow axis, which is decided by KOBRA 21ADH or WR, as an a tilt axis (a rotation axis); value of hypothetical mean refractive index; and a value entered as the film thickness.

In the above-described measurement, the hypothetical value of mean refractive index is available from values listed in catalogues of various optical films in Polymer Handbook (John Wiley & Sons, Inc.). Films the mean refractive indices of which are unknown can be measured by using an Abbe refract meter. Mean refractive indices of some major optical films are listed below: cellulose acetate (1.48), cycloolefin polymer (1.52), polycarbonate (1.59), polymethylmethacrylate (1.49) and polystyrene (1.59). KOBRA 21ADH or WR calculates nx, ny and nz, upon enter of the hypothetical values of these mean refractive indices and the film thickness. Base on thus-calculated nx, ny and nz, Nz=(nx−nz)/(nx−ny) is further calculated. ΔRth is defined by the following numerical formula.

ΔRth=|Rth(630)−Rth(480)| Formula (4)

### (3) Glass Transition Temperature (Tg) of Film

A film sample (5 mm×30 mm) is moisture-conditioned at 25° C. and 60% RH for 2 hours or more and then measured by a dynamic viscoelasticity meter (DVA-225; manufactured by IT Keisoku Seigyo K.K.) under the conditions of a gripping distance of 20 mm, a temperature rising rate of 2° C./min and a frequency of 1 Hz. Then, the temperature at the intersection between a straight line extending from low temperature side to high temperature side in the temperature dependency curve of the dynamic storage modulus thus formed and a tangent line as the gradient in the straight line portion after the dynamic storage modulus abruptly decreases is determined as the glass transition temperature.

### (4) Haze of Film

Haze is measured by subjecting a cellulose acetate film according to the invention to a measurement at 25° C. and 60% RH according to JIS K-6714 by using a haze meter (HGM-2DP, manufactured by Suga Test Instruments Co., Ltd.).

### (5) Measurement of Tear Strength

Tear strength is measured by using an Elmendorf tear strength machine in accordance with JIS K 7128. The measurement is made in an atmosphere at 25° C. and 60% RH.

### (6) Measurement of Elongation at Break

By using a tensile machine, a sample (1 cm in width, 1 cm in measurement sample length) is stretched at a speed of 1000%/min and the break point is determined. The measurement is made in an atmosphere at 25° C. and 60% RH.

TABLE 2

| | | Film | | Rough- | | | | | | Tear | |
|---|---|---|---|---|---|---|---|---|---|---|---|
| | | thickness | Surface | ness | Re | Rth | ΔRth | Tg | Haze | strength | Break |
| Example | | (μm) | planarity | (μm) | (nm) | (nm) | (nm) | (° C.) | (%) | (N) | point |
| Comp. | 1 | 51 | B | 0.055 | 1.5 | 3 | 15 | 160 | 0.5 | 0.10 | 30 |
| Ex. | 2 | 80 | B | 0.045 | 0.6 | 5 | 25 | 158 | 0.8 | 0.23 | 25 |
| Ex. | 3 | 50 | A | 0.035 | 0.6 | 2 | 15 | 160 | 0.4 | 0.20 | 45 |
| Comp. | 4 | 48 | B | 0.050 | 1.0 | −8 | 20 | 165 | 0.4 | 0.12 | 28 |
| Ex. | 5 | 52 | B | 0.048 | 0.8 | −8 | 22 | 160 | 0.4 | 0.11 | 35 |
| | 6 | 80 | B | 0.045 | 0.6 | −10 | 30 | 165 | 0.4 | 0.25 | 20 |
| Ex. | 7 | 50 | A | 0.032 | 0.4 | −8 | 10 | 168 | 0.5 | 0.24 | 40 |
| | 8 | 52 | A | 0.035 | 0.5 | −8 | 12 | 165 | 0.4 | 0.22 | 35 |
| Comp. | 9 | 50 | A | 0.040 | 2.0 | −5 | 15 | 140 | 0.6 | 0.12 | 45 |
| Ex. | 10 | 50 | A | 0.038 | 2.5 | 35 | 25 | 140 | 0.5 | 0.09 | 40 |

As Table 2 shows, it can be understood that the optical films according to the invention each shows a good surface planarity, a Tg that is neither too high nor too low, a large elongation at break and favorable handling properties (being not brittle but flexible).

Using the samples 3, 7 and 10 as described above as protective films, polarizing plates shown in FIGURE and liquid crystal display devices are fabricated in accordance with the fabrication methods as will be described below. The obtained samples are employed as the protective films A1 and A2 for the upper polarizing plate and the lower polarizing plate.

### <Protective Films H1 and H2>

A commercially available cellulose acetate film (FUJITAC TD80UF, manufactured by Fuji Photo Film Co., Ltd.) is employed as protective films H1 and H2.

### <Polarizing Film>

Iodine is absorbed onto a stretched polyvinyl alcohol film to prepare a polarizing film that is employed herein.

### (Fabrication of Polarizing Plate)

Each of the transparent film samples 3, 7 and 10 is dipped in an aqueous 1.5 N sodium hydroxide solution at 40° C. for 2 minutes, washed in a water-washing bath at room temperature, and neutralized with 0.1 N sulfuric acid at 30° C. Next, the film is washed again in a water-washing bath at room temperature and then dried with hot air at 100° C.

Next, a rolled polyvinyl alcohol film of 80 μm in thickness is continuously stretched to 5-fold in an aqueous iodine solution and dried. The thus obtained polarizing film of 20 μm in thickness is bonded between the alkali-saponified transparent film as described above and the protective film above by using an aqueous 3% polyvinyl alcohol (PVA-117H, produced by Kuraray Co., Ltd.) solution as the adhesive, thereby giving a polarizing plate.

### <Fabrication of IPS-Mode Liquid Crystal Cell>

On a glass substrate, electrodes are provided in such a manner as to adjust the distance between adjacent electrodes to 20 μm, and a polyimide film is provided thereon as an alignment film, followed by a rubbing treatment. Separately, another glass substrate is prepared and a polyimide film is provided on one surface thereof followed by a rubbing treatment, thereby giving another alignment film. These two glass substrates are superposed and laminated so that the alignment films face each other with a gap (d₁) of 3.9 μm between substrates and the rubbing directions of two glass substrates run in parallel. Subsequently, a nematic liquid crystal composition having a refractive index anisotropy (Δn) of 0.0769 and a positive dielectric constant anisotropy (Δ∈) of 4.5 is enclosed therein. The d₁Δn value of the liquid crystal layer is 300 nm.

### (Liquid Crystal Display Device)

The polarizing plate obtained above is laminated on both sides of the IPS-mode liquid crystal cell by using a pressure-sensitive adhesive in such a manner that the optical film of the present invention is provided in the liquid crystal cell side. The polarizing plate in the viewing side is laminated so that the abnormal light refractive index direction of the liquid crystal composition in the liquid crystal cell and the absorption axis of the polarizing plate can cross at right angles when no voltage is applied. On the other hand, the absorption axis of the polarizing plate in the backlight side is provided to cross with the absorption axis of the polarizing plate on the viewing side at right angles.

### (Evaluation)

The light leakage and tint change in the 45° oblique direction at black display of this IPS panel are observed. In the display devices wherein the above-described samples 3 or 7 as the protective film A1, it can be confirmed at a glance that the light leakage and tint change when obliquely viewed are small as compared with the display device using the commonly employed FUJITAC TD80UF polarizing plate and the sample 10 as the protective film A1. This effect is established by the small Re and Rth values of the protective film.

The optical film of the invention has an optical isotropy and sustains an excellent surface planarity and a high strength even in the case of reducing the film thickness.

The entire disclosure of each and every foreign patent application from which the benefit of foreign priority has been claimed in the present application is incorporated herein by reference, as if fully set forth.

What is claimed is:

1. An optical film comprising:
a cellulose acylate that has a weight-average molecular weight of 300,000 or more; and
a compound that is capable of decreasing a retardation in a thickness-direction and has a weight-average molecular weight of 1,000 or more.

2. The optical film of claim 1, wherein
the weight-average molecular weight of the cellulose acylate is from 300,000 to 500,000.

3. The optical film of claim 1, wherein
the weight-average molecular weight of the compound capable of decreasing the retardation in the thickness-direction is from 3,000 to 10,000.

4. The optical film of claim 1, wherein
the compound capable of decreasing the retardation in the thickness-direction is polymethyl methacrylate.

5. The optical film of claim 1, which has a film thickness of 30 to 60 μm.

6. The optical film of claim 1, wherein
an in-plane retardation of the optical film is from 0 nm to 20 nm at the wavelength of 630 nm, and
the retardation in the thickness-direction of the optical film is from −20 nm to 20 nm at the wavelength of 630 nm.

7. The optical film of claim 1, which satisfies the following formula (1):

|Rth(630)−Rth(480)|≦20 Formula (1)
wherein
Rth(630) represents the retardation in the thickness-direction of the optical film at the wavelength of 630 nm, and
Rth(480) represents the retardation in the thickness-direction of the optical film at the wavelength of 480 nm.

8. A polarizing plate comprising:
a polarizer; and
the optical film of claim 1 that is a protective film of the polarizer.

9. A liquid crystal display device comprising:
the polarizing plate of claim 8.
